(19) United States
(12) Patent Application Publication
(10) Pub. No.: US 2009/0294573 A1
(43) Pub. Date: Dec. 3, 2009

(54) Dual-Use Modular Propulsion surveillance Vehicle with Detachable Unmanned Airborne Vehicles

(76) Inventors: Samuel B. Wilson, Halifax, VA (US); Paul Gelhausen, Yorktown, VA (US); Andrew Turnbull, Newport News, VA (US); Michael Roberts, Australian Capital Territory (AU); Ignacio Guererro, Blacksburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/301,491

(22) PCT Filed: May 23, 2007
(86) PCT No.: PCT/US07/69569

§ 371 Date: May 13, 2009

Related U.S. Application Data
(60) Provisional application No. 60/802,518, filed on May 23, 2006.

(51) Int. Cl. B64D 5/00; G06G 7/48

(52) U.S. Cl. 244/2; 703/7

(57) ABSTRACT

The present invention provides a system for reconnaissance using autonomous unmanned airborne vehicles (UAV). The system comprises a mothership, which is generally a fixed wing fuel tank capable of providing a suitable surface for flight (lift) and one or more elements for attachment of individual UAVs. The system further comprises one or more UAVs that are detachably connected to the mothership, and which are independently controllable for reconnaissance and tracking. The system and its individual parts are reusable and independently controllable, permitting low cost reconnaissance over wide areas of geography.

This application relies on the disclosure of, and claims the benefit of the filing date of U.S. Provisional Patent Application No. 60/802,518, filed May 23, 2006, the entire disclosure of which is hereby incorporated herein by reference.

### BACKGROUND OF THE INVENTION

### Field of the Invention

The present invention relates to the field of unmanned autonomous vehicles. More specifically, the present invention relates to unmanned autonomous air vehicles, which can be used for surveillance of objects and pre-defined geographic areas.

### SUMMARY OF THE INVENTION

There currently exists a need for an optimized, autonomous system to provide persistent monitoring of a variety of geographical areas, such as national borders, demilitarized zones, airfields, military installations, government buildings, and for general civilian protection.

For example, today's airfields are faced with many threats that can range in size; a single sniper up to a quasi-military unit of enemy fighters or terrorists. The former, smaller threat being harder to detect is therefore a design point in defining criteria to create a robust system solution for airfield surveillance and force protection. The latter threat also poses unique criteria to consider, such as various weapons used during an attack, swarming and/or having multiple points of attack, as well as group tracking.

In addition, national borders now more than ever require constant monitoring to reduce or eliminate illegal immigration and transport of dangerous substances from one country to another.

The most efficient and cost effective solution for these and other threats involves airborne vehicles. To be effective, these vehicles should be able to cover large amounts of ground area efficiently while gathering exploitable data. In addition, these vehicles should not require substantial man-hours for operation and maintenance.

The present invention provides a solution to the need in the art by providing an unmanned autonomously controlled airborne vehicle for surveillance of an object or a geographical area. In contrast to other solutions that provide airborne surveillance, which rely on dropping one or more unmanned airborne vehicles (UAVs) from another aircraft, the present invention uses a base vehicle (also referred to herein as a mothership) to carry one or more UAV on a mothership, for example on a wing of the mothership, only as long as it is desired or needed on the wing.

The present invention includes autonomous unmanned airborne vehicles (UAVs), for example, for air surveillance of pre-selected geographical areas or of objects of interest, said UAV comprising a self-contained fixed wing composite vehicle (e.g. mothership or base vehicle) comprising multiple sub-vehicles (e.g., drones), each of which can independently operate as an UAV. For example, the present invention provides an autonomous unmanned airborne vehicle (UAV) for air surveillance of objects or geographical areas comprising a self-contained fixed wing vehicle as a first vehicle, and at least one sub-vehicle capable of being released from or joined with said first vehicle and capable of operating as an autonomous unmanned airborne vehicle.

The present invention additionally provides UAVs comprising a self-contained fixed wing composite vehicle comprising multiple sub-vehicles, each of which can independently operate as an UAV and, wherein each sub-vehicle can provide both propulsion and electrical power.

The present invention additionally provides UAVs comprising a self-contained fixed wing composite vehicle comprising multiple sub-vehicles, each of which can independently operate as an UAV and, wherein each sub-vehicle can provide both propulsion and electrical power and can provide flight control.

The present invention includes autonomous unmanned airborne vehicles (UAVs) comprising a self-contained fixed wing composite vehicle comprising multiple sub-vehicles, each of which can independently operate as an UAV and, wherein each sub-vehicle comprises replaceable pods comprising one or more functionalities.

The present invention includes autonomous unmanned airborne vehicles (UAVs) comprising a self-contained fixed wing composite vehicle comprising multiple sub-vehicles, each of which can independently operate as an UAV and, wherein each sub-vehicle comprises replaceable pods comprising one or more functionalities, wherein the functionalities are selected from heat detectors, sound detectors, movement detectors, and light detectors.

The present invention includes autonomous unmanned airborne vehicles (UAVs) comprising a self-contained fixed wing composite vehicle comprising multiple sub-vehicles, each of which can independently operate as an UAV and, wherein each sub-vehicle comprises replaceable pods comprising one or more functionalities, wherein the functionalities are selected from heat detectors, sound detectors, movement detectors, and light detectors, including wherein the detector is a video or still camera for capture of visual spectra or for capture of infrared (IR) spectra.

Additionally provided is a reconnaissance system comprising at least one UAV comprising a self-contained fixed wing composite vehicle comprising multiple sub-vehicles, each of which can independently operate as an UAV, and comprising a ground control center for landing and takeoff of the UAV, and optionally for control of communication between the UAV and one or more other components of the system. Optionally, such a system comprises a ground control center comprising one or more computers. For example, included is a reconnaissance system for air surveillance of an object or a geographical area comprising at least one self-contained fixed wing vehicle as a first vehicle, and at least one sub-vehicle capable of being released from or joined with said first vehicle and capable of operating as an autonomous unmanned airborne vehicle.

Further provided is a method of providing reconnaissance comprising providing at least one self-contained fixed wing vehicle as a first vehicle, and providing at least one sub-vehicle capable of being released from or joined with said first vehicle and capable of operating as an autonomous unmanned airborne vehicle, optionally providing at least one ground control center. Optionally, any system or method of the invention comprises one or more computers.

In accordance with the present invention, each UAV is integral to a larger system, but detachable, and each carries its own weight using its own propulsion system. A system according to the invention can comprise a main vehicle or mother ship having at least one detachable (releasable) UAV. Each UAV of the system includes at least one sensor so that the vehicle and the sensor can maintain contact with the target continuously, as opposed to current systems that employ a second sensor.

The mothership is a composite vehicle comprising a flying wing fuel tank with one or more individual UAVs detachably connected to it. For example, the mothership may comprise multiple UAVs, including, for example, one, two, three, four, five, six, seven, eight, nine, ten, or more individual and independently controlled UAV, each UAV being independently releasable from the mothership. In general, the mothership has smaller attached UAVs, each providing avionics/flight control, propulsive power, and sensor capabilities for the mothership vehicle but are also able to operate independently when released from the mothership. The detachable and modular nature of the system permits surveillance of a larger area than would be possible with a single surveillance unit, and allows for controlled and varied surveillance of different terrain or under different conditions (e.g. differing weather conditions, where a target or potential target is identified, etc.).

Speaking generally, the system of the invention is a self-contained, fixed wing vehicle that calls smaller UAVs from one of multiple ground stations. The invention encompasses a system in which a mothership may have multiple pods that can be easily and quickly changed. In embodiments, these pods are a combination of fuel and sensors. For example, for clear daylight missions, simple lightweight television cameras might be all that is required for adequate surveillance, a fact which increases the amount of fuel and endurance capabilities of the system and each UAV individually. In contrast, night missions might require heavier IR (infrared) systems, which could be installed, or interchanged with, the “daylight pods” to provide the desired surveillance. For the very challenging dawn/dusk and reduced visibility timeframes the vehicle might benefit from a more expensive sensor system (or both EO, electro-optical, and IR sensors), which could be installed for the vehicles flying during those shorter segments of the day. The notion is to have the vehicles configured at the airbase and easily and quickly reconfigured as needed by failures or changing conditions.

The mothership and system in general has scalable, line replaceable, units. It has long endurance and low cost components, as opposed to monolithic engines/wings. According to the present invention, system maintenance can be spread over a longer period of time to improve resource utilization.

The concept of the present invention is ideal for long duration surveillance and reconnaissance missions. For example, the border patrol mission might be the most intriguing; however, the invention is not limited to that specific mission. It could monitor any long-range sensitive potential target: airfields, pipelines, borders, etc.

Unmanned airborne vehicles for homeland defense must be operationally robust and also have the ability to operate at lower altitudes. The majority of UAVs currently available for operation were built for military missions, and, in the near term, some of these vehicles will be adapted for homeland defense. The Department of Defense's Unmanned Aircraft Systems Roadmap, released in August 2005, notes that the Department of Homeland Security (DHS) is evaluating several UAVs for border security, Coast Guard and maritime missions, transportation, security, and protection of critical infrastructure. Military operations are characterized by shorter-term high intensity operations where manpower and cost are treated differently than a constant surveillance mission lasting for decades, where you hope never to find any “bad guys” but the failure can be catastrophic. The present invention provides a significant improvement in operations in these areas.

### BRIEF DESCRIPTION OF THE DRAWINGS

The accompanying drawings, which are incorporated in and constitute a part of this specification, illustrate several embodiments or features of the invention, and together with the written description, serve to explain certain principles or advantageous features of embodiments the invention.

FIG. 1 depicts an example of a mothership and associated UAVs according to one embodiment of the invention.

FIGS. 2a and 2b depict an embodiment of a UAV of the invention.

FIG. 3 depicts a graph showing baseline fuel consumption of an embodiment of a UAV of the invention as compared to another system available in the field.

FIG. 4 depicts a graph comparing the thrust provided and required for an embodiment of the invention and another system available in the field.

FIG. 5 depicts a graph comparing the lift-to-drag (L/D) ratios between the baseline and Border Eye embodiment of the present invention.

FIG. 6 depicts a graph showing the relationship between the wing area and aspect ratio (AR) of one embodiment of the invention.

FIG. 7 depicts a graph showing exemplary gross weight vs. root thickness to cord.

FIG. 8 depicts a graph showing exemplary cruise drag vs. root thickness to cord.

FIG. 9 depicts an exemplary GC travel diagram.

### DETAILED DESCRIPTION OF VARIOUS EMBODIMENTS OF THE INVENTION

Reference will now be made in detail to various exemplary embodiments of the invention, examples of which are illustrated in the accompanying drawings.

The autonomous airborne vehicle system of the present invention showcases a simple flying wing-shaped fuel tank that is the backbone for the attachment of a number of deployable UAVs. The flying wing can be of any appropriate shape, and in embodiments is little more than a fuel tank shaped like an airfoil with minimal control mechanisms, few moving parts, and no electronics. Such a design is possible because the attached UAVs provide all the major avionics/flight control, propulsive power, and sensor capabilities for the vehicle system.

A multiple UAV per system approach was determined to be an optimal solution for the various different surveillance tasks faced by governments in the world today. Given this conclusion, it was realized that at least one of the vehicles in the system should be a constant eye-in-the-sky (a.k.a. main vehicle). To achieve this, there are then three options: 1) the main vehicle is accompanied by other vehicles flying separately that can investigate possible threats; 2) the main vehicle(s) acts as a mothership by carrying smaller vehicles as integrated propulsion units and dropping these self-sufficient vehicles at certain time intervals to either investigate a possible detection or return to base; and 3) the main vehicle(s) fly at altitude, and smaller ducted fan Micro Air Vehicles (MAVs) wait on the ground at either a single or several strategic locations for a request from the main vehicle to investigate a possible detection.

The first option is a conventional approach to surveillance and is inherently inefficient. The multiple aircraft's duplicative capability during the loitering phase of the mission is an inherent compromise between the ability to loiter for long periods of time and the close-up tracking ability needed for troop support. This option would most likely involve expensive gimbaled sensors with a strong zoom capability.

It was concluded that the second option is preferable to the first. This strategy increases endurance by dropping engines as fuel is burned and the vehicle becomes lighter and less thrust is required. The main vehicle acts chiefly as a flying fuel tank with a processor to coordinate the other engines for control and determine drop intervals. The second option may also have one or several pod attachment (sensors/fuel) locations for flexibility of operations. This option allows versatility in designs for different missions and endurance. Being able to change sensors, have multiple sensors, or add more fuel tanks can also lead to less expensive, single-function sensors that are replaced less frequently. For example, there is usually no need to carry an IR camera during the day or an EO camera at night. Carrying only one of these cameras and adding fuel tanks will increase the endurance of the vehicle during both day and night operations. During the shorter periods of dawn and dusk, the vehicle may be equipped with both sensors and perhaps a microwave sensor, which will be heavier, but the same amount of endurance is typically not needed for these transition segments.

The third option presents more of a separated system solution. The MAVs may have their own safe box where they can be sheltered and connected to a fuel reservoir and data link. While on the ground, the MAVs may be positioned to perform a perched surveillance of the perimeter. Operating autonomously, these vehicles would only require scheduled maintenance and periodic filling of the fuel reservoir, which results in a cost-reduction benefit.

Both the second and third options provide a much more robust system solution than the first, and form aspects of the present invention. These two system types also present possibilities to reduce risk and increase the ease of use through unique mission operations. Having a vehicle constantly watching at altitude allows for communication between the main vehicle and MAV, which helps with collision avoidance and tracking issues. The combination of the output of these sensors also provides friendly ground forces with an enhanced situational awareness, including the ability to see what the target is doing up close as well as the target's general location and movement from a more distant perspective. Depending on the variations in airfield size, adding more motherships can add scalability to the system design.

With regard to tracking, the current systems can deploy one of its propulsive UAVs, allowing it to track the target without compromising the main aircraft's mission. It also provides a zooming capability that greatly aids in identification and provides a lot of flexibility in tracking any recognized threat.

In embodiments, beneficial attributes include use of ducted fans as a dual function; first as the propulsion system for the flying wing, and second as an independent UAV that can perform tracking and surveillance as well as a return-to-base task.

In some embodiments, the feeder aircraft or independent UAVs (ducted fans) can fly up and dock with the mothership, a concept which is distinct and can be complementary to the situation where the ducted fans fly themselves back to a location, such as a ground control or base for servicing, or independently operate for surveillance.

In some embodiments, different sensors or combinations of sensors are included on the mothership, and thus on one or more individual UAVs. In this way, various information can be obtained from one vehicle, which can be used for surveillance or evaluation of hardware and control of the hardware. For example, the requirements on the visual and IR sensor can be evaluated. There are three levels of visual sensing that require different resolutions (pixels on target) for the operation to be successful. They are: detection (˜four pixels), recognition (˜eight pixels), and identification (˜sixteen pixels). An enemy with clothing, a weapon, and possibly other supplies as viewed from above or at different angles from a relatively high altitude may have an area of three ft×two ft (or six ft²). If Stinger missiles are a threat, then the area defined above of 7,000 ft² may need to be monitored. With such a large area, it may be cost effective to mount a less expensive visual sensor on the long endurance eye-in-the-sky with a resolution that will only detect and recognize a person. A smaller vehicle with an even less expensive camera could then fly in for a closer look. This would provide an effective zoom capability that allows a less expensive sensor setup and possibly a more suitable, low speed/hover capable, steady aircraft to identify and track the target(s).

Depending on the type of threats being considered and the size of the area under surveillance, the coverage ability and frequency of the sensor sweeps from a single integrated aircraft, such as that employed by current systems in the art, may be inadequate to provide the necessary surveillance. Further, if there is only a single vehicle orbiting the area and should it be directed for closer inspection of a target or troop support, the area is then susceptible to the single vehicle being distracted by decoys, false positives, or even multiple points of attack. According to the present invention, these drawbacks are overcome.

The mothership and its constituent UAVs can be powered by any means. Accordingly, it and they may be powered by internal combustion engines, electric motors, solar/electric motors, hybrid electric, etc. The choice of type of propulsion system can be made in consideration of duration, noise, weight, and other factors known in the art. Of course, it is preferable that the propulsion system should be sized for the mission endurance, with extremely low fuel consumption while providing enough thrust and electrical power for efficient loiter flight. Weight and cost trades will typically ultimately make this decision.

In general, airframe design will be geared towards the highest possible lift-to-drag ratio (for best loiter) that accommodates the sensor design and the type of propulsion. Weight savings and endurance benefits resulting from the use of light composite materials can be compared against possible additional cost when making the decision as to materials for each particular build out of the embodiment. The airframe design can, in embodiments, include ducted fan technology, such as demonstrated by AVID LLC and Honeywell's MAV flight vehicle, adding a zooming and tracking capability to the surveillance system.

The systems of the invention preferably comprise computing, communications, and collision avoidance. There are several steps involved in aerial video surveillance; sensing, front-end processing, scene analysis, camera control, geo-location, aerial mapping, compression and transmission, display, and archiving. Other steps to consider are flight path generation, collision avoidance, video mosaicing used in aerial mapping, and three dimensional (3D) scene construction if desired. The more computing that needs to occur onboard the aerial vehicle, the larger the electronic system needs to be and the more power it will require for operations, which has the drawback of limiting endurance. In certain situations, such a limitation may not be acceptable. Therefore, a portion of the computing can take place on a ground-based system that communicates with the vehicle, although in some cases the bandwidth will limit the amount of data that can be sent at one time.

Concerning mission management, the vehicle will autonomously fly programmable flight paths (i.e., no remote control of vehicle control surfaces). In this way the vehicle can have a nominal patrol pattern defined by the operator, but will not require continuous attention. In embodiments, Honeywell's autonomous micro air vehicle project and systems derived from it may be used in the present system. The system of the invention may use ground schematics or topographical maps as input to help with sensing requirements and may provide video mosaic aerial mapping. This will allow the system along with other inputs, such as probable threats, threat transportation modes, and critical defense points, to generate a statistically best-suited automatic flight path. The navigation system can maintain the ability to have the flight path manually overridden in real time by an operator if a region of interest needs investigation.

It is also envisioned that the vehicle can automatically modify its flight path to investigate a newly detected threat. When this happens, it will preferably alert the operator to the change in course and graphically highlight the sensor output. The sensor video overlain on a static background image with sensor independent zoom and panning capability will be available to friendly ground troops within (at least) a one km radius.

If there are multiple/swarming threats in the area and the UAVs are outnumbered, either the ground troop or the system may decide which enemy poses the most threat, and follow that particular enemy. In the event of a loss of communication, it may be desirable for the UAV to record the sensor information and resume transmitting the data once the link is re-established. The navigation system may also be used for automatic takeoff, refueling, and landing scheduled to avoid conflicts with normal airfield operations. All sensor data transmitted to the control station preferably will be recorded and archived for each mission flown.

Other embodiment options include a camera with a means of rotation or translation, or having multiple cameras with overlapping field of views mounted on the vehicle. The cameras may rely on any technology, including but not limited to visual spectrum recording, IR recording, UV recording, etc.

Decision-aid tools can be used to design an integrated system according to the invention. For example, a decision-aid tool is available from AVID LLC to assist system designers in selecting the ideal combination of vehicle and sensor package for a given application. Software Pixels On Target (SPOT) combines a UAV flight simulator with the ability to control sensor parameters such as field of view, resolution, frames per second, and sensor orientation. Instead of system designers needing to build a vehicle, mount a camera, and perform test flights to study the quality of visual data that can be collected by the system, designers can perform trade studies on sensor parameters and vehicle stability to develop an optimal system for an application.

The AVID OAV (organic air vehicle) is a multidisciplinary design tool developed by AVID LLC for the design and optimization of small, unmanned air vehicles. The AVID OAV code incorporates geometry, aerodynamics, structures, propulsion, and weights into the analysis of perspective vehicles. The analysis results in predicted performance and vehicle dynamics. This information can be used as input into SPOT so that the effects of vehicle dynamics on video quality can be evaluated. The effect of the sensor on the UAV performance is also evaluated by integrating the sensor power requirements into the UAV energy budget. The energy budget is utilized by SPOT to determine the duration of a simulated flight. OAV will also give results for endurance and performance based on sensor weight and placement. Using SPOT along with other analyses, trades studies will be evaluated to determine the optimal payload combination and its effect on the overall system.

Other simulations that may take place based on the risk associated with the methods and technology include automated take-off and landing, tracking, flight path generation, and ground coverage of the sensor systems. These studies can be accomplished using any number of computer programs, including the MATLAB tool from AVID.

Although the present system and individual components may be used in any number of situations, it is envisioned that there will be five main uses for the system.

The mission scenarios are as follows:

Border Patrol: This mission requires constant surveillance of a nation's borders, watching for any trespasser trying to cross into the country without going through a legal checkpoint. The present invention addresses this mission well.

First Responder Support: This mission requires a small, highly maneuverable UAV able to negotiate tight spaces, in low light and with scattered debris to collect intelligence about a certain place or situation. The UAV could be looking for a country's own citizens who have been hurt or people with hostile intent that are hiding in some place that is difficult for humans to enter (e.g. damaged buildings, subway tunnels, etc.). It is envisioned that local agencies will be the purchasers and users of the systems and vehicles of the invention for this mission scenario.

High Value Asset Security: This mission is for airport, nuclear power plant, and other high value fixed asset perimeter protection. To avoid costly human patrols, the current solution involves fences and sensors to identify when the perimeter has been crossed and human guards can be dispatched to the site from a center location. According to the present invention, UAVs capable of responding to a tripped sensor could be housed in unmanned stations (containers like missile launch silos) around a facility perimeter. Beyond identifying when and where a breach has occurred, the UAVs would provide “eyes on target” for the security personnel who could be at the central location. The information from the UAV would inform security of the specifics of the breach from the time of the breach and beyond. Security would decide whether to send a mechanical or a manned team.

Port Security: In this scenario, a UAV identifies incoming ships and is able to detect the presence of explosives, weapons, or harmful items prior to the ship entering the harbor.

Covert Surveillance: The present invention uses small UAVs as a part of the overall system. The small individual UAVs can be used to track targets of law enforcement interest. Today the mission requires local agencies to follow a suspect with multiple law officers each in their own automobile. With a covert UAV, the suspect can be followed and the law officer is in a control-vehicle (van) recording information from the UAV. Not only are efficiencies in cost achieved by such embodiments, but safety for officers and the general public can be substantially increased. Under surveillance with a system of the present invention, the target under surveillance may react more predictably if the target is unaware of the surveillance, which the present invention provides in this scenario. Further, fewer officers are at risk if not required at the immediate scene.

Of the above-mentioned possible uses, a mission to secure the U.S. borders was selected as an activity to be further exemplified herein as an embodiment of the invention. It is to be understood that the invention is not so limited, and the present invention can be applied or modified for use in any surveillance situation. Furthermore, while surveillance and security of the U.S. and Mexican border is exemplified, it is to be understood that any object, border, or geographical area may be a target for surveillance.

Border patrol missions along the U.S.-Mexican border require round-the-clock surveillance and are supported out of a select few bases along the border. According to the invention, the mothership cruises in a specified orbit at an altitude of approximately 20,000 feet. The altitude was determined by a sensitivity analysis of various parameters. Individual UAVs are released either at specified intervals to optimize engine performance, or as needed to track a potential suspect. Furthermore, UAVs can be released from the mothership when the thrust the UAV provides is no longer needed, allowing the other UAVs' engines to run at near maximum performance. If a target is detected by the sensors of the “captive” UAVs on the mothership, then a ducted fan (hover capable) UAV will be released to identify the specifics of the target and track that target until Border Patrol authorities can reach the scene. The UAV flies back to the nearest base for recovery when finished and then the UAV is prepared for the next mission when the empty mothership returns.

The Border Patrol has experimented with several Military UAVs (e.g. Hunter, Predator, etc.) and has a number of manned aircraft (both fixed wing and helicopters) but the cost of maintaining constant surveillance over the entire US-Mexican border with manned aircraft is far too expensive. The Military UAVs offer a reduction in cost (over manned aircraft) but are still very expensive. The U.S. Air Force (USAF) has estimated that they require three Predator vehicles to keep one Predator in an orbit continuously. Published sources state: “The MQ-1 Predator is a system, not just an aircraft. A fully operational system consists of four aircraft (with sensors), a ground control station, a Predator Primary Satellite Link, and approximately 55 personnel for deployed 24-hour operations.” (http://www.af.mil/factsheets/factsheet.asp?fsID=122). Using this information, it can be seen that the system requires 136 predators and 1,870 personnel plus any Border Patrol officers to arrest the violators. The Predator carries a payload of 450 lb, which is more than the sensor payload required.

The three important tasks a surveillance aircraft tasked with border patrol must accomplish are: 1) detect a potential target; 2) identify that target as dangerous or not dangerous; and 3) track a dangerous target until such time that it can be intercepted. The first and second tasks can easily be accomplished from any altitude, but the third task can be problematic given the aircraft's constraint of maintaining coverage with the aircraft preceding and following it. Worse yet, the target could easily hide from or out maneuver an aircraft flown thousands of feet above ground. In contrast to presently available technologies, the system of the present invention achieves all three tasks with minimal, if any, detectable drawbacks.

With any airborne surveillance concept, the first step is to define the sensor required to accomplish the mission. The capabilities of the sensor will define the number of aircraft needed to cover any given area, the aircraft operational altitude, and the aircraft speed. The present invention provides the tools for defining the sensors required, and can rely on currently available technologies to perform this task.

As part of the sensor optimization, it is desirable to determine observation altitude. The search for an appropriate observation altitude is multi-faceted. The choice of altitude is a delicate balance between the number of aircraft needed versus the cost, complexity, and weight of the onboard sensor. The higher the altitude, the fewer the aircraft needed but the more costly the sensor must be to detect, identify, and recognize the target activity. The key to determining the distance that each aircraft can cover (which determines the number of aircraft required) is the slant angle at which the sensor can identify. Since there is no off-the-shelf IR lightweight sensor that is capable of this mission at any altitude higher than 10,000 feet, the design should be generated around a few assumptions. For this mission, a slant angle of 66° is chosen for a mildly aggressive estimate of current capability.

The next assumption deals with whether it is necessary to continuously monitor the entire border or whether it is operationally possible to allow a gap in the coverage between aircraft sweeps. There are two ways to define this gap, both as an interval in time and as a linear distance. The latter distance is added to the loop size that each aircraft must fly and therefore greatly decreases the necessary aircraft aloft and the former defines the speed the aircraft must fly in order to maintain the time gap assumed for that linear distance. It is convenient to define the linear sensing distance in terms of the distance that the onboard sensor can see at any given time. Therefore, 1 SD is equivalent to the distance between the ground intersections of the sensor sweep at either of its extremes. Such calculations are typical in the art, and results vary according to the various parameters. Those of skill in the art are well aware of parameters to input to achieve a result that is satisfactory for the particular embodiment of the present system under development.

In general, a UAV of the invention will operate according to a Line Replaceable Unit (LRU) maintenance philosophy. The design reality of this philosophy involves incorporating a modular design. To the extent possible, each element of the mothership (each UAV) is a line replaceable unit. Ideally, the flying wing will be little more than a fuel tank shaped like an airfoil with minimal control mechanisms, few moving parts, and no electronics. In this instance, each of the remaining UAVs will be removed upon return to base. The flying wing/fuel will be assessed for potential structural damage or leaks. If none is detected, operational UAVs will be loaded (plug and play) onto the trailing edge of the flying wing, forming the entire unitary vehicle and the vehicle will return to mission. Meanwhile, the individual UAVs that were removed, will be serviced, and restocked for plug and play loading onto the next vehicle returning to base. Because in many circumstances there will be about five orbits per base there will be UAVs returning frequently and there will always be ready UAVs to attach to the mothership. The turn-around time for the mothership is the driver for the total number of vehicles needed to perform the mission.

As a non-limiting example of a calculation for a base-deployed system, the following parameters may be determined:

40 hours TOS and 16 hours time away per vehicle, then you need 63 air vehicles, which is equivalent to 20 hours TOS for 8 hours away or 80 hours TOS to 32 hours away.

45 vehicles aloft and 8 bases with two extra air vehicles per base translates into 61 total vehicles that will permit five motherships to stay aloft continuously.

If the time away doubles (to 32 hours for 40 hours TOS) then another 8 vehicles are necessary for a total of 68 vehicles.

If the time away decreases by half (to 8 hours away for 40 hours TOS) then you only need a total of 53 vehicles (one extra vehicle) per base.

This maintenance philosophy will allow an incredibly efficient operational scenario. Essentially, the flying wing needs no spares, and the UAV sparing can be evaluated based upon the maintenance needs as more operational time occurs. Additionally, the maintenance philosophy generates efficiency on the part of the maintainers. They will not be rushed and under pressure 5% of the time, and training and waiting 95% of the time. Instead, the maintainers will have UAVs on-the-shelf that need to be evaluated and/or serviced. Maintainers can work in non-emergency status most all of the time, servicing the UAVs and storing ready UAVs for the next mission, while the vehicles are operational. There will not be a time critical event where an UAV must be fixed immediately, or the mission will have to abort.

The maintenance philosophy allows for minimal sparing of the mothership, and larger sparing for the UAVs. Reliability for the UAVs is not as significant when the Line Replaceable Unit philosophy is used. Sparing may be impacted by reliability, but the operational scenario and reliability of the mission will not be impacted.

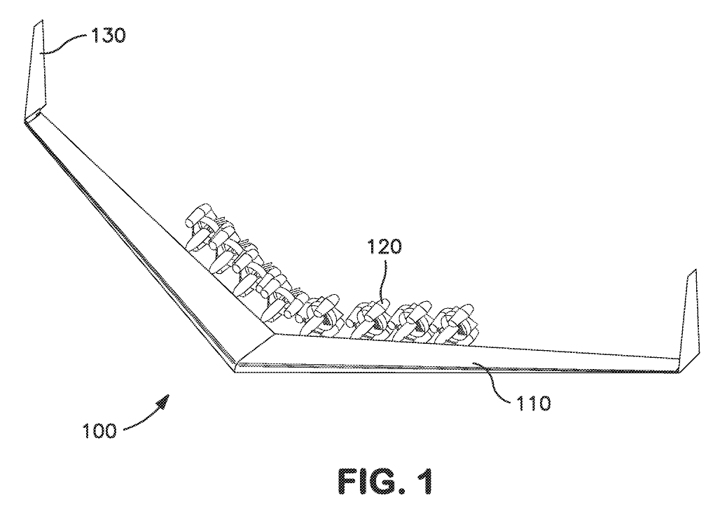

As depicted in FIG. 1, which shows one embodiment of the mothership concept (100), a structural flying wing (110) that hosts and depends upon smaller UAVs (120) for its propulsion and sensor capabilities comprises the system. Each mothership (110) will have a designated operational loop or orbit, at an altitude of approximately 20,000 ft. When the mothership leaves the base, it will report to and relieve the mothership currently flying in the designated loop. The mothership will operate for approximately 40 hours, releasing UAVs as necessary to operate efficiently and/or to identify and track a target until border patrol agents can reach the suspect.

Meanwhile the mothership, relieved of its operational loop, will return to base to be serviced. Ideally, there will be no structural damage to the mothership, and the UAVs will be removed and replaced with new UAVs. Turnaround time will be very quick, assuming no structural damage, and the mothership with new UAVs will relieve another mothership from its operational loop. The basing and operational philosophy for the mothership is succinct. If there is nothing to service, then service will be quick and operational time will be optimized.

Although the number of UAV per mothership is not limited, in general, each mothership will comprise at least seven UAV. In embodiments, each mothership will release at least five UAVs. While not limiting, this is considered the optimum minimum number required to generate superior intelligence about the entire field of view for the specific operational loop. The UAVs will maintain all of the equipment required to identify and track a suspect.

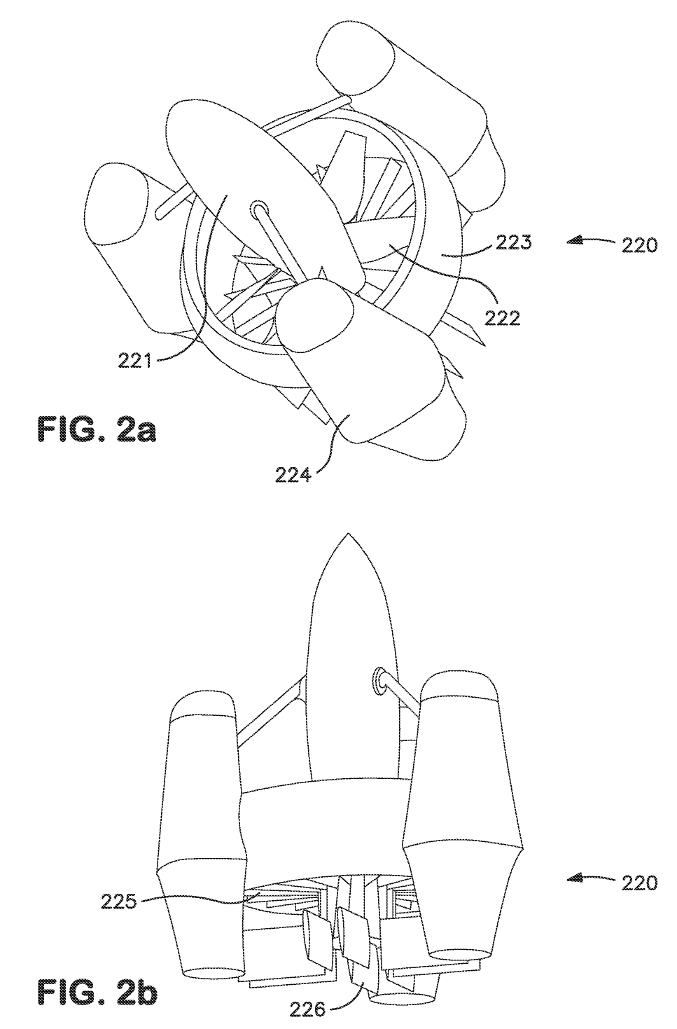

As depicted in FIGS. 2a and 2b, in general, the UAVs are mini-jet ducted fans that have the capability to fly down and hover about a suspect until border patrol agents can make it to the scene. The UAV is capable of hover for up to about 2 hours or more, if no return to base leg is needed. All bases from which the system operates are preferably less than 2 hours from any operational loop. In other words, border patrol agents should be able to make it to a target within the time that the UAV can sustain hover.

If no suspects are identified, the mothership can drop UAVs as required to ensure the most efficient mission from the perspective of optimal engine performance. When a mothership runs out of UAVs or its performance will be deteriorated to the point where it cannot return home if another UAV is released, the mothership will be replaced in its orbit, and will return to base.

When a UAV is released, it will have the capacity to return to base under its own power, or if tracking a target, the UAV will be transportable and can be put in the back of the border patrol vehicle to be returned to base.

The exact method of employment by the practitioner can be widely varied and is not a limitation on the invention. Non-limiting benefits to the present system are as follows: 1) First of all, the mothership will be a constant, consistent eye in the sky. The combination of the fields of view of all of the mothership ensures a constant picture of the entire geographical area of interest, e.g. the U.S.-Mexican border; 2) The UAVs will be able to drop from the mothership to track identified targets. A trigger mechanism will notify the UAV of their sub mission, and they will release. Once the suspect is properly identified, and confirmed, border patrol will be notified and the UAV will hover, or sit down and perch until border patrol arrives. The UAV also has the option to cruise back to base on its own power if the target doesn't require a border patrol intercept.

In a typical embodiment, the UAV is embodied with a ducted fan, mini-jet engine, with sensors powerful enough to detect and identify targets. The UAV quickly descends to track targets and, upon reaching a target, has the capability to hover or cruise at up to 200 mph or more while tracking the target and can fly for several hours until border patrol agents arrive to take charge of the situation. The UAV provides the border patrol the ability to determine whether the “target” constitutes sending out personnel to investigate, such as identification of objects not of interest, for example a stray cow from a nearby farm, etc. The border patrol personnel can recover the UAV if they are present or the UAV can fly back to base autonomously when it is no longer needed on the scene.

Each design for the border patrol mission is optimized for the specific mission. The staged design allows for the most efficient system, and the ducted fan UAVs embody a specific design element to identify and track suspects. Furthermore developing dedicated vehicles and associated sensors, specifically designed for a particular need, such as Homeland Defense, will provide a significant improvement in capability for each mission.

At this point, it is interesting to note that one of the challenges conceptual aircraft designers face is designing an engine and scaling the thrust for a phase of the mission that is not the longest and/or most efficient. Often, engines are sized for takeoff, single-engine out, or even the need for a particular cruise speed. Even the best concepts size the engine to be at its most efficient at the beginning of the first cruise or loiter segment. As the aircraft burns off fuel and loses weight, the drag drops accordingly. By the beginning of descent, the engine is usually throttled back a significant amount from its optimum efficiency. One answer to this problem is, obviously, the cruise-climb mission profile. As the weight and drag associated with providing the lift comes down, the aircraft climbs, maintaining the more optimum cruise point. Unfortunately, for this concept, and a number of other cases, it is necessary to fly at a fixed altitude, negating the cruise-climb option.

If the small vehicle deployed to track a ground target can also be used as part of the propulsion system of the main aircraft, another answer to the oversized engine presents itself. The deployable UAV is released either upon demand to track a target or when the reduction in drag is equal to that engine's thrust. This release of the UAV drops not only weight off the airframe but also significant drag, yielding an increase in mission endurance. Comparing the same mission, the option to retain the propulsive UAVs rather than dropping them regularly costs over 11% of the aircraft's endurance.

The most likely choice for a sensor technology suited for human detection is EO/IR. Given a mission of providing continuous coverage, day or night, the IR half of the sensor should be able to provide sufficient coverage.

As can be seen in FIGS. 2a and 2b, in embodiments, the ducted fan UAV (220) houses a small turbine engine (221) directly in front of and powering an advanced fan (222) inside the airfoil-shaped duct (223). There are three pods (224), one of which carries the camera and all of which carry retractable landing gear which is used to land at home base or to perch and stare around a tracked target if it finds a suitable place to do so. The torque produced by the engine is canceled by a set of stators (225) behind the fan and a set of movable control vanes (226) behind those to control the UAV's attitude and stability. The UAV can hover under the thrust of its fan (half the thrust comes from lift off the duct lip) or it can tip over tens of degrees and fly forward, partially supported by the lift off of what is now a ring wing.

Each ducted fan UAV is “plugged” into the trailing edge of a flying wing with vertical tails on the wingtips (130) for directional stability, as depicted in FIG. 1. The connection is made through the engine pod in the center and provides communications between UAVs and fuel connections with the tanks in the wing. The design for this concept is to make the flying wing as “dumb” as possible. The use of “BlueTooth”—like technology allows the UAVs to communicate with each other without any wiring in the wing. The design for the UAV is such that it contains all the propulsion, a large majority of the control authority, the sensors and the “brains” for the entire composite aircraft. In essence, in embodiments, the flying wing is relegated to being simply a flying fuel tank for the mothership. This philosophy greatly improves the overall aircraft system reliability due to the short turnaround times of the composite flying vehicle and the modular maintainability, repair, or disposal of the complex parts of the system. For example, if one sensor fails or another malfunction occurs, the UAV is cast off to return to the base and the aircraft continues to fulfill its mission. When the UAV arrives at the base, it can be examined, fueled, and readied for the next mission before the mothership returns. If any of the UAV's subsystems are defective, then the UAV can be shipped back to the manufacturer for repair.

When the aircraft is left with the minimum number of UAVs required to maintain level flight, it returns and lands at the base. In some embodiments, that minimum number is three UAVs. However, in other embodiments, it is fewer or more.

Each ducted fan engine was designed in AVID's UAV code and then input and scaled in ACS. Each UAV is released with full fuel and is always considered to be at release weight when onboard the aircraft. The UAV releases itself from the trailing edge of the aircraft by reversing the prop and then gliding down in a stable manner from 20,000 feet to approximately 11,000 feet, where it can sustain its own flight. The dimensions and specifications of one embodiment of the ducted fan UAV are given in the following table:

TABLE 1
UAV parameters

| | | |
|---|---|---|
| Propeller Diameter | 24 | in |
| Engine Power, SL | 60 | hp |
| Tmax @ 20k ft, 311 ft/s | 31 | lb |
| Friction Drag @ 20k ft, 311 ft/s | 3 | lb |
| Net Forward Force | 28 | lb |
| Release Weight | 123 | lb |
| Camera Weight | 40 | lb |
| Fuel Weight | 29 | lb |
| ANPR (Empty) Weight | 54.1 | lb |
| Turbine Weight | 24.1 | lb |
| Airframe Weight | 32 | lb |

In one embodiment, the UAV (FIG. 2b) uses a small turbine engine producing approximately 19 hp at 20,000 feet at a weight of 24 lbs. The current state of the art is reflected in two products, the PT50 engine developed by Turbine Tech, and the LTS-60, developed by Locust Technologies. Both engines are currently capable of producing that power at that weight and altitude.

The engine is mated to a variable pitch fan that produces 31 lbs of thrust at design altitude and speed. The variable pitch mechanism is more than capable of producing the required thrust to hover at any altitude below approximately 11,000 feet at release weight.

On the fuel consumption side, in the small turbine world, an emerging technology is the use of a recuperator on the exhaust side of the turbine. This is a simple device that transfers heat from the exhaust to the inlet tract through a series of interlocked channels. This heats the intake charge, reducing the amount of work the combustor needs, thereby reducing the input potential work (e.g. fuel). This device can produce a fuel consumption reduction up to 40%.

To appreciate the advantage of this type of system, it is beneficial to understand what a conventional approach to the same mission would yield in terms of overall weight as well as other mission-related penalties. For this exercise, the baseline system must accomplish all the mission goals of detecting, identifying, and tracking any potential threats. Because such a system does not currently exist, the baseline system must consist of two types of aircraft, one that detects and identifies, and a second aircraft that tracks.

One such baseline that illustrates the difference between onboard and on-demand tracking is a system that has a similar flying wing to the present system, but is powered by a single turboprop. The flying wing would have an equivalent sensor suite that would allow it to detect and identify in the same manner as the present system. When a threat is detected, the main base is notified and dispatches a ground-based UAV, very similar to the Class II OAV Honeywell, in partnership with AVID, is building for DARPA. This UAV is capable of cruising 50 nautical miles (nm) at close to a mile a minute, hovering for an hour, and then returning the same 50 nm back to base. This concept is similar in appearance to the UAV of the present invention except that it is 31″ in diameter and weighs 170 lbs when full of fuel.

The mothership of the present invention releases 5 UAVs from its wings during its typical 40 hour endurance and so to provide the same capability, the baseline system has a fleet of 5 UAVs on standby dedicated to each airborne platform. The baseline is powered by a scaled down PW118 turboprop and produces 150 hp for this mission. It is given no fuel consumption credit (or penalty for scaling down), has the same 40 hour endurance, and carries a 320 lb sensor payload (total weight of the sensors carried by the mothership of the present invention). The baseline system is intended to compare the current state of the art against the future missions the system of the invention is designed to accomplish.

In Table 2 below, it is seen that the present system (labeled “Border Eye”) is approximately 4% greater in gross weight over the baseline system:

TABLE 2

| | Baseline | | Border Eye | |
|---|---|---|---|---|
| Gross Weight | 4,229 | lb | 5,274 | lb |
| Empty Weight | 1,739 | lb | 2,754 | lb |
| T/W | | | | |
| Fuel Weight | 1,880 | lb | 2,521 | lb |
| Wing Area | 180 | ft² | 185 | ft² |
| # of Engines | 1 | | 8 | |
| Sea Level HP/eng | 150 | hp | 60 | hp |
| Class II OAVs on demand | | | | |
| 5 OAVs × 170 lbs | 850 | lb | 0 | lb |
| System Weight | 5,079 | lb | 5,274 | lb |

However, the 4% penalty hides a few shortcomings in the baseline system that are less quantifiable. The baseline system has up to an hour of response time before the ground-based UAV arrives, compared to a few minutes for the present system. Also, during this time, the baseline aircraft takes the chance of losing contact with the potential target as it continues to fly its mission. Finally, the baseline system doesn't take advantage of the line-replaceable unit (LRU) maintenance philosophy, as explained above with regard to the present invention.

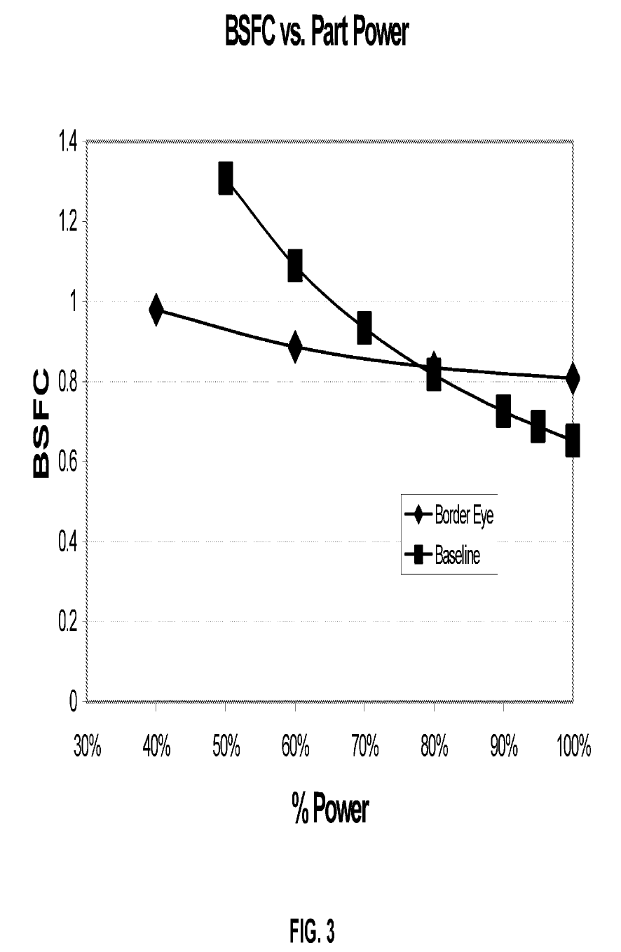

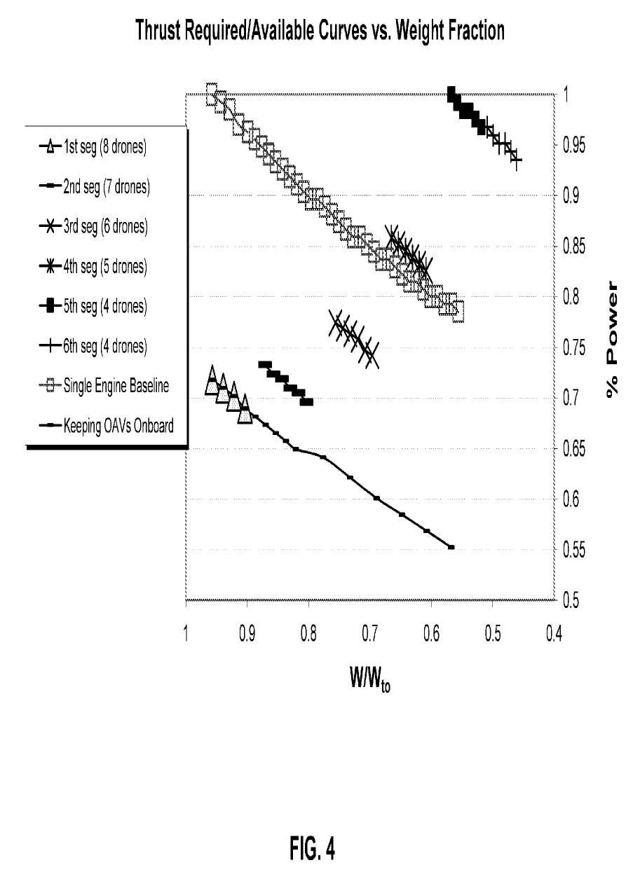

FIG. 3 shows that the baseline engine has a lower fuel consumption at high power levels than the ducted fan powered UAV of the invention. And, in fact, during the mission the baseline does keep the throttle above 80%, as shown in FIG. 4.

FIG. 4 also shows the interesting phenomenon of decreasing SFC as the mission goes on. Since the stepped propulsion concept drops off finite amounts of thrust potential every 400 min or so, the remaining engines increase their throttle to compensate, each becoming more efficient as the mission lengthens. Instead of the engines being sized for takeoff and climb, they are sized for the end of the mission when there are a minimum left. This is the primary reason why a minimum of three engines yielded a lighter gross weight than a 2 engine concept. One opportunity for optimization, shown unrealized by this graph in the current concept, is the less than optimal part power performance at the beginning of the mission. If the part power at the beginning of the mission is raised above 80% (by sizing the engines smaller or including a “large” fixed engine), then the entire mission can be compared favorably to the baseline in this aspect. The challenge to the smaller engines is the fact that it needs to carry a certain size and weight of sensor and the challenge to the large fixed engine is the increase in complexity of the mothership and a partial loss of the LRU maintenance philosophy.

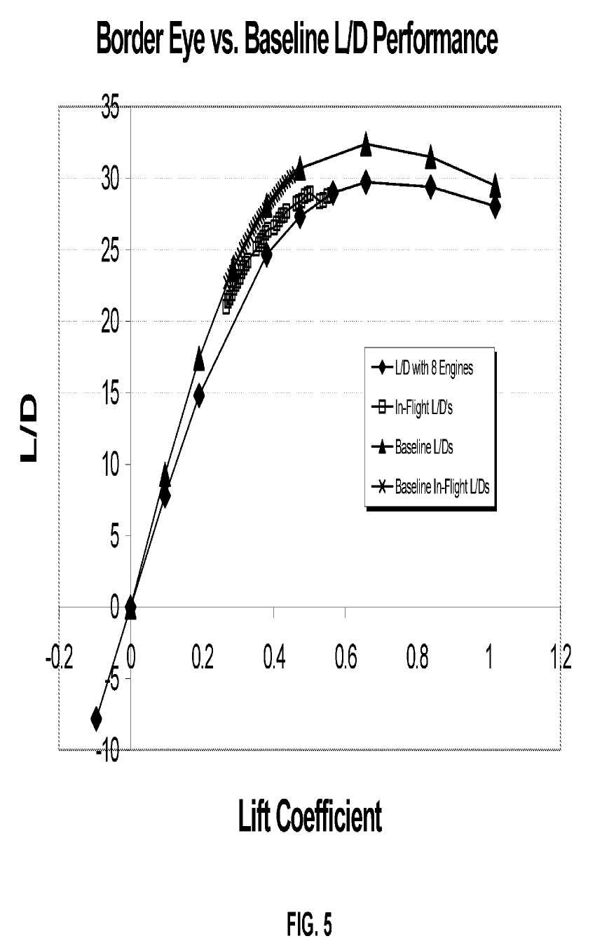

FIG. 5 shows a comparison of lift-to-drag L/D ratios between the baseline and Border Eye embodiment of the invention. The baseline has a higher L/D ratio due to the lower propulsion drag and weight. Due to the UAV of the present invention's wing area being constrained by fuel volume, Border Eye flies on the front side of the L/D curve. If desired, the design may be altered in other embodiments to provide alternative fuel storage options to lower the wing area.

The smaller, closely grouped icons in the figure depict the L/Ds actually found in flight. One interesting note is the fact that as Border Eye drops engines, the L/D leaps off the takeoff L/D curve and starts to approach the baseline L/D curve as the mission comes to a close. This is simply due to the reduction in propulsion drag and weight.

Most, if not all, conceptual aircraft design codes are not compatible with the idea of modular, deployable propulsion systems. The solution described here involves running several ACS files, each a step in the process towards converging on a relevant weight, utilizing this unique propulsion concept. The starting point of this process incorporates a weight estimate that is guaranteed to be heavier than the actual concept. This is done by modeling the aircraft without deploying any ducted fans throughout the mission. Because the engines are kept onboard throughout the mission, the aircraft not only carries their extra weight and drag along but also uses more fuel than it would if they were dropped at regular intervals. So the goal of the next few steps is to determine the correct (and lower) fuel weight if the engines are deployed along the mission.

The chosen way to model engine drops in ACS is to model them as deployable stores/weapons and bookkeep the thrust separately. Because ACS only allows two weapon drops per mission, it becomes necessary to run ACS several times, each time only modeling two loiter segments, and passing on the fuel weight from the previous leg as payload. As the engine is deployed at the end of each loiter segment, that particular engine is throttled to zero percent, and the “weapon” is released, taking its associated weight and drag with it.

In order to correctly estimate the fuel required during each segment, the code needs to reflect the state of the aircraft during that portion of the mission. And since the aircraft is carrying only three engines upon landing, it is necessary to fly the last and second-to-last loiter segments first to determine the required fuel weight. That fuel weight is then input in a model for the previous two segments as payload (to prevent ACS from re-sizing it). This process continues backward until the first two loiter segments, that also include the takeoff and climb, are modeled, carrying the fuel weight from all the subsequent stages as fixed payload.

During each stage, the structure and fixed equipment weights are fixed with the values from step one when there are no engine deployments. As a result, when the final, corrected fuel weight is determined through the above process, the structure weight and wing area are oversized for the mission required (since the wing is sized by fuel volume for this concept). In order to get a better estimate of the weight required for the new fuel volume, another step runs an ACS model similar to the first step, flying the entire mission without releasing any of the ducted fans. This model runs with a fixed fuel weight and converges on range and, as a result, resizes the aircraft weights for the given fuel weight and allows the wing area to be reduced to fit the fuel volume needed.

Now because the fixed fuel weight is based upon flying a heavier structure weight and larger wing area, it is also now an overestimation. So the process of flying the mission backward is run again to iterate to a new optimal fuel weight. The cycle continues until the final cycle weight is within a chosen tolerance of the last cycle weight (in this case, 50 lbs).

The following flowchart shows the step-by-step process of a single cycle for an eight-engine UAV model.

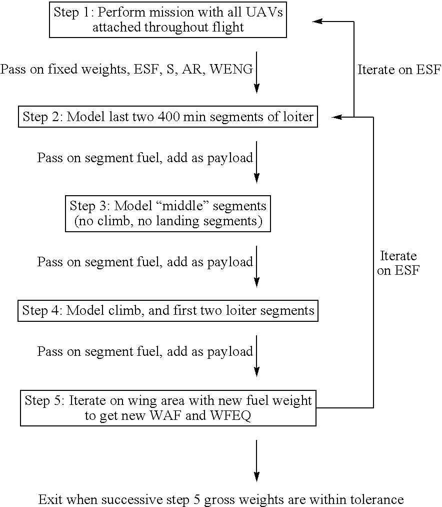

Initial Inputs: Number of ducted fans; Number of UAVs left onboard upon landing; Weight of each ducted fan; D/q for each ducted fan; Mission endurance; Interval between nominal engine drops.

ACS is run with MMPROP set to 8 and the ducted fan thrust is modeled with an engine deck where the input is thrust vs. throttle position vs. SFC. There are two engine decks used for any model of this type. They both have the same thrust and SFC tables but the first one estimates the engine weight and the second one has the engine deck weight set to zero. Both engine decks have zero installation losses. The installation losses are accounted for in the aerodynamics section by inputting D/q's for stores equivalent to the engine drag estimated by AVID's UAV ducted fan design code. The second engine deck is used for engines that will be dropped during that cruise segment. The engine weights, in that case, are kept separately as a missile and a bomb weight so that they can be dropped at the end of the interval.

Step 1

Run ACS with optimizer (set to vary aspect ratio and wing area) modeling the entire mission without dropping any ducted fans.

Parse size of aircraft parameters (wing area, airframe weight, initial engine size).

Engine weight is kept in the engine deck and engine drag for all eight engines is kept in the fixed store drag.

Step 2

Run ACS in analysis mode with the airframe weights, AR, and wing/tail areas from step 1 and then modeling only the last two loiter segments (with a payload drop after each) as well as the descent segment.

Takeoff times set to zero.

Obtain fuel weight needed for this part of the mission.

Input fuel weight from step 2 as payload (WAMMO) in next step (including reserve fuel).

Trapped fuel is fixed at value from step 1.

2 engines keep the engine weight in the engine deck and the engine drag as fixed stores.

2 engines keep the engine weight as weapon weights and their engine drag as deployable stores.

Step 3

Run ACS in analysis mode with fixed airframe weights (plus fuel weight “payload” from step 2), AR, and wing area from step 1 modeling the middle two loiter segments.

Takeoff times set to zero.

Obtain fuel weight needed for this part of the mission.

Input fuel weight from step 2 and add to payload (WAMMO).

Reserve fuel set to zero, trapped fuel is fixed at value from step 1.

4 engines keep the engine weight in the engine deck and the engine drag as fixed stores.

2 engines keep the engine weight as weapon weights and their engine drag as deployable stores.

Step 4

Run ACS in analysis mode with a fixed airframe weight (plus fuel weight “payload” from step 2), AR, and wing area modeling the climb to altitude and the first two loiter segments.

Takeoff times set to defaults.

Obtain fuel weight needed for this part of the mission.

Input fuel weight from step 3 and add to current payload (WAMMO).

Reserve fuel set to zero, trapped fuel is fixed at value from step 1.

6 engines keep the engine weight in the engine deck and the engine drag as fixed stores.

2 engines keep the engine weight as weapon weights and their engine drag as deployable stores.

Step 5

Run ACS in convergence mode with a fixed fuel weight and iterate on range.

Add the fuel weight required in Step 4 to the WAMMO in step 4 and input into the WFUEL variable.

Reserve fuel set to zero.

Takeoff times set to defaults.

Trapped fuel is calculated by ACS.

If there is extra fuel volume in the wing area, the model is run with an iteratively smaller wing until the wing volume matches the fuel volume.

Output new airframe (WAF) and fixed equipment weights (WFEQ), as well as wing area, into an updated Step 2 model and iterate on ESF until the engine thrust, at its most efficient throttle setting, matches the total drag during the last loiter segment.

Further Steps: Once ESF and wing area converge between step 5 and the updated step 2, another iteration of the whole process is performed until subsequent step 5 models have gross weight within a given tolerance.

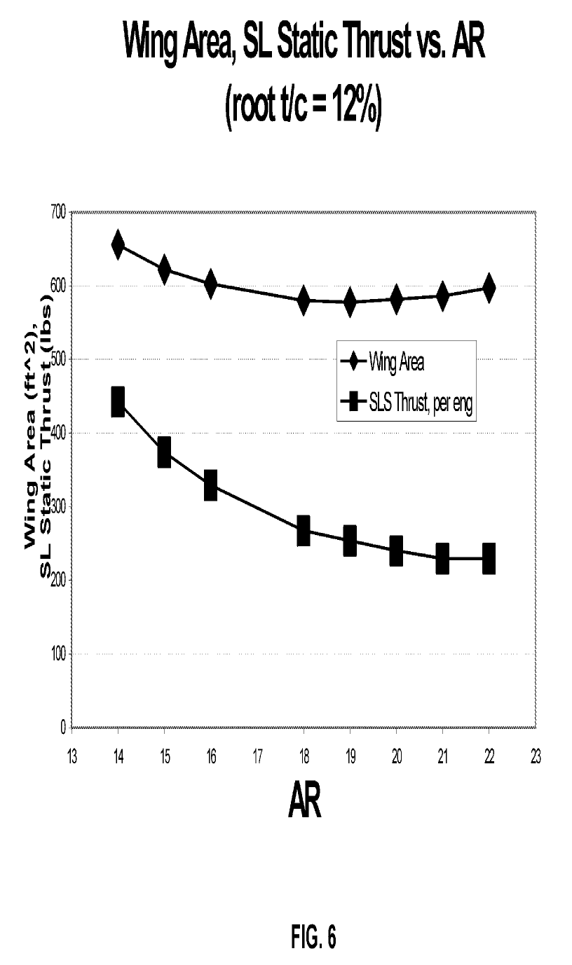

A trade study to determine the optimum aspect ratio was preformed using ACS and, more specifically, the Sanders wing weight equation. A survey of the different wing weight equations in ACS, including PDCYL, and the Sanders equation provided the most intuitive behavior for this particular configuration. The results are shown in FIG. 6. As can be seen, the lowest wing area corresponds to an AR of approximately 19. The engine size obviously decreases with increasing AR, although it, too, starts to flatten out around AR=22. And while the wing weight does start to increase past an aspect ratio of 16, the gross weight also has a minimum at AR=19. Therefore, an aspect ratio of 19 is used for the remaining studies. Note that in this study the trades were done using a Step 1 model, where all the ducted fan UAVs are kept onboard for the entire mission, because it is the only complete ACS model and saves considerable time. It is assumed that the same trends extrapolated to the true weights of this concept. The gross weight scale shown here is typical of the weight seen of Step 1 models.

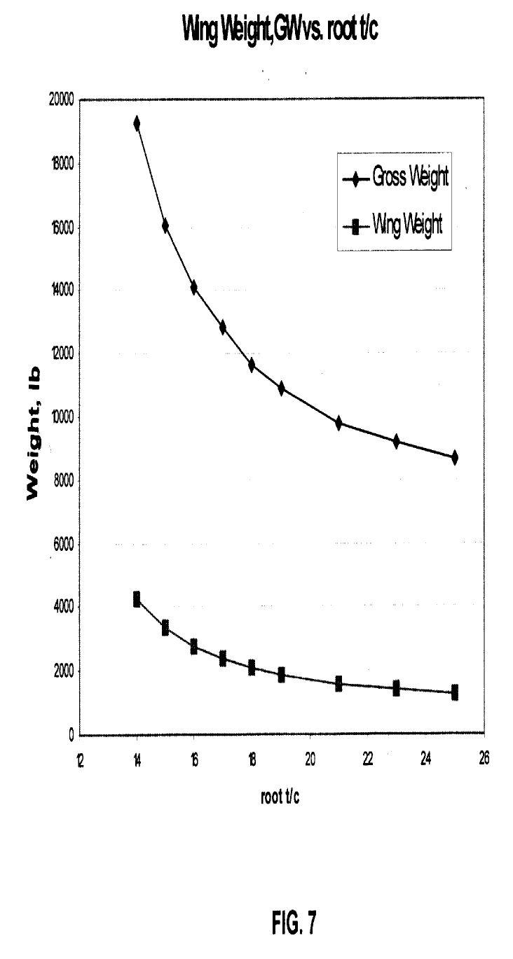

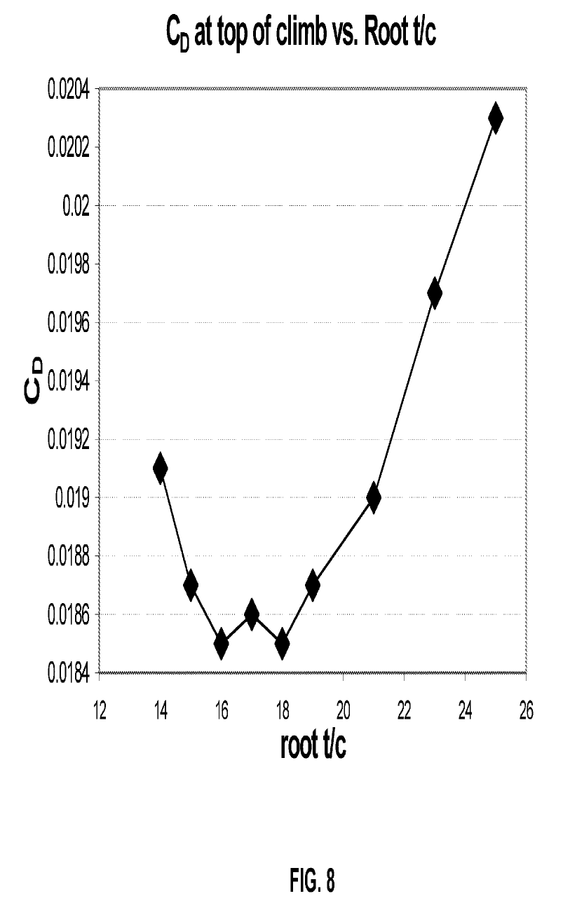

Another interesting conclusion about these trade studies is the profound effect the root thickness to chord ratio has on the overall aircraft weight. As shown in FIG. 7, the reduction in gross weight is over 50% by increasing the root t/c from 15% to 25%. This dramatic trend is due to the fact that this concept is primarily constrained by the fuel volume necessary to accomplish the mission so the extra volume gained through thickness changes far outweighs the cruise drag penalty due to the thicker airfoil (FIG. 8). Variation of the tip thickness has a much smaller impact; the minimum gross weight stemmed from a 12% thick tip airfoil.

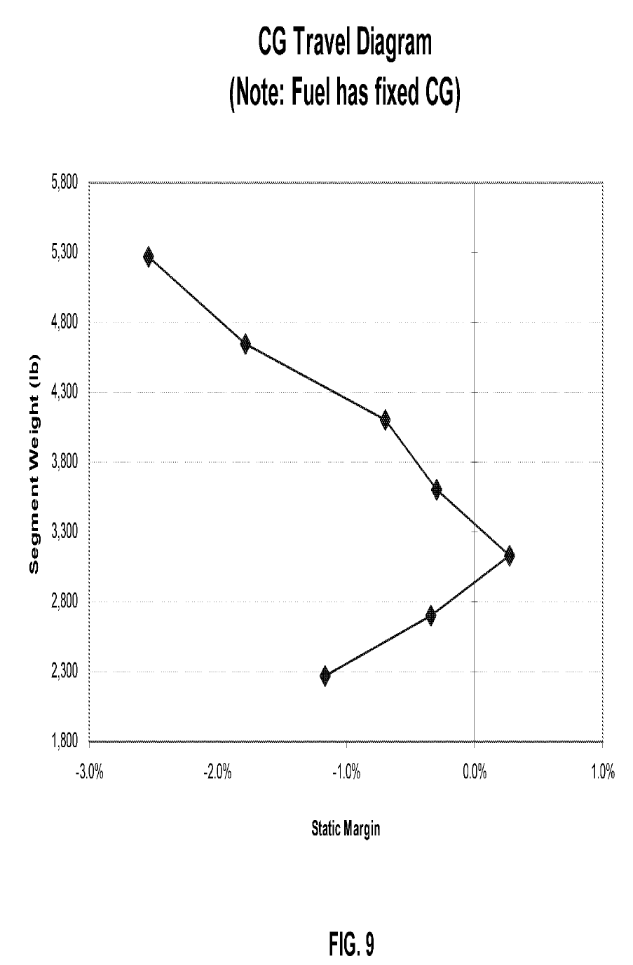

A center of gravity study was performed, and as expected, sweep played a large role in determining the stability. The fuel was assumed to have a fixed CG throughout the mission (obtainable through fuel transfer) and the UAVs were all clustered as close as possible to the centerline of the wing in order to shift the CG as forward as possible. The aircraft balances nicely, as shown in FIG. 9, with a 23.5° quarter chord sweep in the wing.

It will be apparent to those skilled in the art that various modifications and variations can be made in the practice of the present invention and in construction of the mothership and UAVs without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. An autonomous unmanned airborne vehicle (UAV) for air surveillance of objects or geographical areas comprising:
a mothership aircraft capable of carrying multiple sub-vehicles, and
multiple sub-vehicles capable of being released from or joined with said mothership aircraft during flight, and capable of operating as an autonomous unmanned airborne vehicle,
wherein said mothership aircraft depends on, at least in part, at least one of said sub-vehicles for operation of said mothership aircraft.

2. The UAV according to claim 1 comprising up to ten sub-vehicles.

3. The UAV according to claim 1, wherein said mothership operation depends at least in part on at least one of said sub-vehicles for providing propulsion and electrical power to said mothership aircraft.

4. The UAV according to claim 1, wherein said mothership operation depends on at least in part at least one of said sub-vehicles for providing flight control to said mothership aircraft.

5. The UAV according to claim 1, wherein at least one sub-vehicle comprises replaceable pods comprising one or more functionalities, wherein one or more of said functionalities are capable of operating while said sub-vehicle is joined with said mothership aircraft.

6. The UAV according to claim 5, wherein said functionalities are selected from heat detectors, sound detectors, movement detectors, and light detectors.

7. The UAV according to claim 5, wherein at least one sub-vehicle comprises a detector comprising a video or still camera for capture of visual spectra or for capture of infrared (IR) spectra.

8. A reconnaissance system for air surveillance of an object or a geographical area comprising:
a mothership aircraft capable of carrying multiple sub-vehicles, and
multiple sub-vehicles capable of being released from or joined with said mothership aircraft during flight, and capable of operating as an autonomous unmanned airborne vehicle,
wherein said mothership aircraft depends on, at least in part, at least one of said sub-vehicles for operation of said mothership aircraft.

9. The reconnaissance system according to claim 8, further comprising a ground control center.

10. The reconnaissance system according to claim 8, wherein said mothership operation depends at least in part on at least one of said sub-vehicles to provide propulsion, electrical power, or flight control to said mothership aircraft.

11. The reconnaissance system according to claim 8, wherein at least one sub-vehicle comprises replaceable pods comprising one or more functionalities, wherein one or more of said functionalities are capable of operating while sub-vehicle is joined with said mothership aircraft.

12. The reconnaissance system according to claim 11, wherein said functionalities are selected from heat detectors, sound detectors, movement detectors, light detectors and cameras.

13. The reconnaissance system according to claim 9, wherein said ground control center comprises one or more computers.

14. A method of providing reconnaissance comprising:
providing a mothership aircraft capable of carrying multiple sub-vehicles, and
providing multiple sub-vehicles capable of being released from or joined with said mothership aircraft during flight, and capable of operating as an autonomous unmanned airborne vehicle,
wherein said mothership aircraft depends on, at least in part, at least one of said sub-vehicles for operation of said mothership aircraft,
optionally providing at least one ground control center.

15. The method of providing reconnaissance according to claim 14, wherein said ground control center comprises one or more computers.

16. A method of designing or optimizing, by computer modeling, autonomous unmanned airborne vehicles (UAV) or reconnaissance systems for air surveillance of objects or geographical areas comprising:
(1) modeling a flight mission for a modular, deployable propulsion system with all unmanned airborne vehicles on board throughout flight,
(2) modeling last two loiter segments,
(3) modeling middle two loiter segments,
(4) modeling climb to altitude and first two loiter segments,
(5) modeling with fixed fuel weight and iterating on range,
(6) outputting airframe, fixed equipment weights, and wing area and input into (2) above, iterating on ESF until engine thrust at most efficient throttle setting matches total drag during the last loiter segment, and
(7) upon ESF and wing area convergence between (5) and updated (2) above, iterating whole process again until subsequent models from (5) above have gross weight within a given tolerance.
